(19) United States
(12) Patent Application Publication
(10) Pub. No.: US 2023/0029575 A1
(43) Pub. Date: Feb. 2, 2023

(54) Transmission and Drive System of a Motor Vehicle

(71) Applicant: ZF Friedrichshafen AG, Friedrichshafen (DE)

(72) Inventors: Johannes Kaltenbach, Friedrichshafen (DE); Martin Brehmer, Tettnang (DE); Fabian Kutter, Kressbronn (DE); Matthias Horn, Tettnang (DE); Stefan Beck, Eriskirch (DE)

(21) Appl. No.: 17/788,033

(22) PCT Filed: Mar. 23, 2021
(86) PCT No.: PCT/EP2021/057363

§ 371 Date: Jun. 22, 2022

(30) Foreign Application Priority Data
Apr. 22, 2020 (DE) 10 2020 205 090.2

(51) Int. Cl. B60K 6/365; B60K 6/442; B60K 6/547

(52) U.S. Cl. CPC B60K 6/365; B60K 6/442; B60K 6/547; B60K 2006/4833

(57) ABSTRACT

A transmission (2) of a motor vehicle includes a first input shaft (7), a second input shaft (8), an output shaft (9), a first sub-transmission (5) including the first input shaft (7), and a second sub-transmission (6) including the second input shaft (8). The second sub-transmission (6) is a planetary transmission having components including a sun gear (24), a ring gear (22), and a carrier (23). Additionally, the transmission (2) includes an engaging device (S3) associated with the planetary transmission (PG). In a first engagement position (E) of the engaging device (S3), a first component (23) of the components of the planetary transmission (PG) is connected to the second input shaft (8). In a second engagement position (F) of the engaging device (S3), a second component (22) of the components of the planetary transmission (PG) is connected to the second input shaft (8).

### CROSS-REFERENCE TO RELATED APPLICATION

The present application is related and has right of priority to German Patent Application No. 10 2020 205 090.2 filed on Apr. 22, 2020 and is a nationalization of PCT/EP2021/057363 filed in the European Patent Office on Mar. 23, 2021, both of which are incorporated by reference in their entirety for all purposes.

### FIELD OF THE INVENTION

The invention relates generally to a transmission of a motor vehicle. In addition, the invention relates generally to a transmission system of a motor vehicle.

### BACKGROUND

US 2017/0129323 A1 describes a transmission of a motor vehicle, particularly a hybrid vehicle. The transmission includes a first input shaft, to which a first prime mover is coupleable, and a second input shaft, to which a second prime mover is coupleable. Moreover, the transmission includes an output shaft, to which a drive output is coupleable. The first input shaft is an integral part of a first sub-transmission for the first prime mover. The second input shaft is an integral part of a second sub-transmission for the second prime mover. Each of the sub-transmissions is a spur gear drive according to US 2017/0129323 A1. The two sub-transmissions are coupleable to one another via a shift element arranged on a countershaft.

The transmission according to US 2017/0129323 A1 needs a relatively large installation space and has a relatively high weight.

### SUMMARY OF THE INVENTION

A new type of transmission of a motor vehicle and a transmission system having the new type of transmission are disclosed herein.

The transmission includes a first input shaft for a first prime mover.

In addition, the transmission includes a second input shaft for a second prime mover.

The transmission has a first sub-transmission including the first input shaft for the first prime mover.

The transmission has a second sub-transmission including the second input shaft for the second prime mover, wherein the second sub-transmission is a planetary transmission having components including at least a sun gear, a ring gear, and a carrier. Depending on the definition, at least planetary gears are also included if these are not defined as part of the carrier.

The first sub-transmission for the first prime mover is a spur gear drive having intermeshing gearwheels, where the first prime mover is preferably an internal combustion engine.

The transmission includes at least one countershaft. Preferably, in one example embodiment, the transmission has two countershafts.

The second sub-transmission for the second prime mover is a planetary transmission, where the second prime mover is preferably an electric machine.

An engaging device is associated with the planetary transmission, wherein, in a first engagement position of the engaging device, a first component of the planetary transmission is connected to the second input shaft and, in a second engagement position of the engaging device, a second component of the planetary transmission is connected to the second input shaft. Due to the engaging device, a changing ratio of the second sub-transmission is achieved.

A particularly compact is implemented for the transmission according to the invention. The reasoning therefor is that, among other things, the second sub-transmission is a planetary transmission. The countershafts are relatively short due to the second sub-transmission being a planetary transmission. One further installation space-related advantage is implemented in one example embodiment when each of the shift elements associated with the second sub-transmission is a double shift element.

According to one advantageous refinement, the second output shaft is permanently coupled to a countershaft via a gearwheel arranged coaxially to the first input shaft. Preferably this is the sole point of connection to the output.

Preferably, in one embodiment, precisely two fixed gears are arranged on the first input shaft. The two fixed gears are preferably arranged in a double engagement, i.e., each fixed gear meshes with two idler gears, which is particularly compact.

Preferably, in some embodiments, the gearwheel arranged on the countershaft, which is coupled to the second input shaft, is a fixed gear.

Advantageously, the second prime mover is connected to the ring gear of the planetary transmission. As a result, the planetary transmission is simplified.

Advantageously, in one embodiment, a separating clutch associated with the first input shaft is provided for the decoupleable connection of the first prime mover to the first input shaft.

According to one advantageous refinement, a third prime mover is present, which is an electric machine, wherein the third prime mover is operatively connected to the first input shaft. For the case in which a further, third prime mover is present, which is preferably an electric machine, as is the case with the second prime mover, further advantages are achieved. Thus, in particular, the third prime mover as an electric machine is operable as a starter generator and improve the function of the transmission and/or of the transmission system including the transmission. For the case in which a separating clutch is additionally present between the first prime mover, which is an internal combustion engine, and the first input shaft, purely electric powershifts is provided when the separating clutch is disengaged. As a result, the operation of a transmission system including the transmission is further improved.

### BRIEF DESCRIPTION OF THE DRAWINGS

Preferred refinements result from the dependent claims and the following description. Exemplary embodiments of the invention are explained in greater detail with reference to the drawing, without being limited thereto, in which:

FIG. 1 shows a diagram of a transmission system of a motor vehicle with a first exemplary embodiment of a transmission;

FIG. 2 shows a gear shift matrix of the transmission system from FIG. 1;

FIG. 3 shows a list of exemplary ratio values of the transmission system with the first exemplary embodiment of the transmission shown in FIG. 1;

FIG. 4 shows a diagram of a transmission system of a motor vehicle with a second exemplary embodiment of a transmission;

FIG. 5 shows a diagram of a transmission system of a motor vehicle with a third exemplary embodiment of a transmission;

FIG. 6 shows a diagram of a transmission system of a motor vehicle with a fourth exemplary embodiment of a transmission;

FIG. 7 shows a diagram of a transmission system of a motor vehicle with a fifth exemplary embodiment of a transmission;

FIG. 8 shows a diagram of a transmission system of a motor vehicle with a sixth exemplary embodiment of a transmission;

FIG. 9 shows a diagram of a transmission system of a motor vehicle with a seventh exemplary embodiment of a transmission;

FIG. 10 shows a diagram of a transmission system of a motor vehicle with an eighth exemplary embodiment of a transmission;

FIG. 11 shows a diagram of a transmission system of a motor vehicle with a ninth exemplary embodiment of a transmission;

FIG. 12 shows a diagram of a transmission system of a motor vehicle with a tenth exemplary embodiment of a transmission;

FIG. 13 shows a diagram of a transmission system of a motor vehicle with an eleventh exemplary embodiment of a transmission; and

FIG. 14 shows a diagram of a transmission system of a motor vehicle with a twelfth exemplary embodiment of a transmission.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

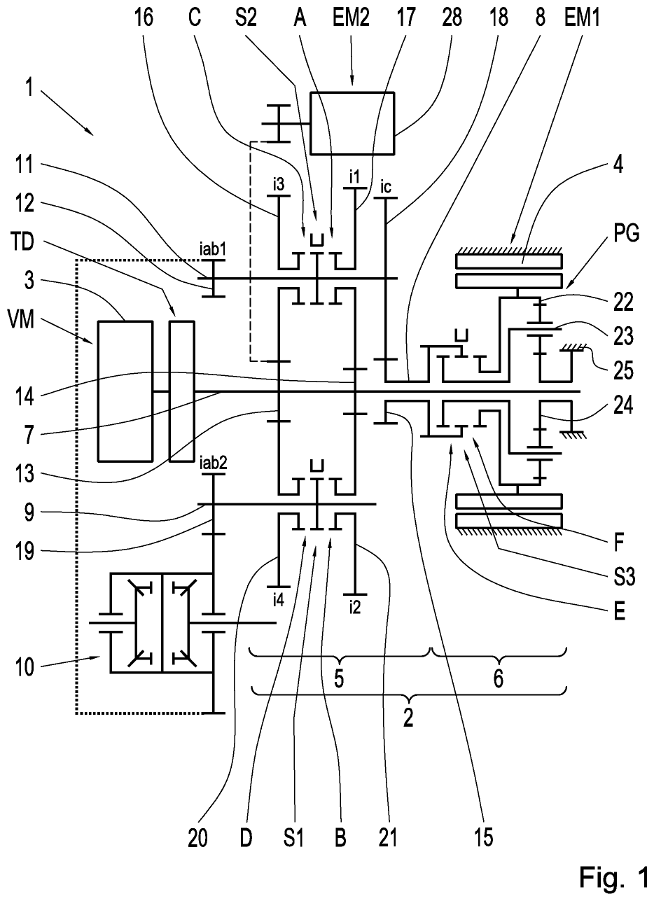

FIG. 1 shows a diagram of a transmission system 1 of a motor vehicle according to the invention, which includes a transmission 2 according to the invention.

The transmission system 1 includes, in addition to the transmission 2, a first prime mover 3 and a second prime mover 4, wherein the first prime mover 3 is preferably an internal combustion engine VM and the second prime mover 4 is preferably an electric machine (e.g., first electric machine EM1). Thus, the transmission system from FIG. 1 is a hybrid transmission system.

The transmission 2 includes two sub-transmissions 5, 6. The first sub-transmission 5 acts as a sub-transmission for the first prime mover 3, which is preferably the internal combustion engine VM, wherein the first prime mover 3 is coupleable to a first input shaft 7 of the first sub-transmission 5 of the transmission 2.

A damping device TD is arranged between the internal combustion engine VM and the first input shaft 7. The damping device TD includes a torsion damper, =a damper, and/or a slipping clutch, where the torsion damper is a dual-mass flywheel and the damper is a rotational speed-adaptive damper.

The second sub-transmission 6 acts as a sub-transmission for the second prime mover 4, which is the first electric machine EM1, wherein the second prime mover 4 is coupleable to a second input shaft 8 of the transmission 2 of the second sub-transmission 6.

In addition, the transmission 2 includes an output shaft 9, which is common to both sub-transmissions 5, 6 and to which a drive output 10 is coupled. A differential is part of the drive output 10, as shown in FIG. 1.

The first sub-transmission 5 includes a first countershaft 11 in addition to the first input shaft 7, to which, in the exemplary embodiment shown in FIG. 1, the first prime mover 3, preferably as the internal combustion engine VM, is permanently coupled. The first countershaft 11 extends in parallel to the first input shaft 7 and has gearwheels 12, 16, 17, 18. The first countershaft 11 has gearwheel meshing with the output shaft 9 and the differential 10 via the gearwheel 12 as a fixed gear.

Other gearwheels 13, 14, and 15 are positioned coaxially to the first input shaft 7. The gearwheels 13, 14 are fixed gears with respect to the first input shaft 7. The gearwheel 15 is not a fixed gear with respect to the first input shaft 7 since there is no rotationally fixed connection. It is also not an idler gear, however, since a shift element is not provided for connecting the gearwheel 15 to the first input shaft 7. The gearwheel 15 is therefore mounted exclusively on the first input shaft 7.

Two shift elements B, D are associated with the second countershaft 9. The two shift elements B, D are preferably formed by a double shift element 51, wherein only one of these shift elements B, D is ever engaged at a time.

When the shift element D is engaged, an idler gear 20 is coupled to the second countershaft 9 in a rotationally fixed manner. When the shift element B is engaged, however, an idler gear 21 is coupled to the second countershaft 9 in a rotationally fixed manner.

Two shift elements A, C are associated with the first countershaft 11. These two shift elements A, C are preferably formed by a double shift element S2, wherein only one of these shift elements A, C is ever engaged at a time.

When the shift element C is engaged, the idler gear 16 is coupled to the first countershaft 11 in a rotationally fixed manner. When the shift element A is engaged, however, the idler gear 17 is coupled to the first countershaft 11 in a rotationally fixed manner.

In this way, four gear steps for ratios i1, i2, i3, and i4 are made available with little installation space solely by the first sub-transmission 5.

The gearwheels 16, 17, and 18 of the first countershaft 11 engage, as described above, exclusively into the gearwheels 13, 14, 15 positioned coaxially to the first input shaft 7.

The gearwheel 19 meshes into the differential of the drive output 10. The gearwheel 20 meshes into the fixed gear 13 of the first input shaft 7, and the gearwheel 21 meshes into the fixed gear 14 of the first input shaft 7.

Accordingly, the first sub-transmission 5 is a spur gear drive made up of intermeshing gearwheels for the first prime mover 3, which is preferably the internal combustion engine VM.

The second sub-transmission 6 is connected to the first sub-transmission 5 via the gear stage is having gearwheels 15, 18. The ratio between the first electric machine EM1 and the first countershaft 11 is influenced via the engagement position of an engaging device S3. Depending on whether and which of shift elements E, F is engaged, either a carrier 23 or a ring gear 22, respectively, as components of a planetary transmission PG, is coupled to the second input shaft 8 and, then, to the first countershaft 11.

The second sub-transmission 6 is a planetary transmission PG for the second prime mover 4, which is preferably the first electric machine EM1. The planetary transmission PG includes the ring gear 22, the carrier 23, and a sun gear 24.

The ring gear 22 of the planetary transmission PG connects to the second input shaft 8 of the transmission 2, namely of the second sub-transmission 6 thereof. In FIG. 1, the first electric machine EM1, which provides the second prime mover 4, is directly and/or indirectly coupleable to the second input shaft 8 and positioned coaxially to the planetary transmission PG, and so the planetary gear set is nested in the rotor of the first electric machine EM1.

The output side of the planetary transmission 6 is formed by the carrier 23 or by the ring gear 22. The sun gear 24 is coupled so as to be permanently fixed to the housing.

The shift elements E, F are associated with the second sub-transmission 6. Depending on the engagement position of the shift elements E, F, one of the components of the planetary transmission PG is coupled to the second input shaft 8. With the shift element E engaged, the carrier 23 is coupled to the second input shaft 8. With the shift element F engaged, the ring gear 22 is coupled to the second input shaft 8.

In summary, the following is said about the embodiment according to FIG. 1:

The two gears for the first electric machine EM1 are formed with the aid of a planetary transmission PG. The ring gear 22 represents the input and the carrier 23 represents the output. The sun gear 24 is permanently fixed to the housing. The first electric machine EM1 is connected to the ring gear 22. The shift element E connects the second input shaft 8 to the carrier 23, enabling a first electric gear E1 to be engaged. The shift element F connects the second input shaft 8 to the ring gear 22 and to the rotor of the first electric machine EM1, enabling a second electric gear E2 to be engaged. The second input shaft 8 is permanently connected to the drive output via a spur gear stage ic. This represents the sub-transmission 6 for the first electric machine EM1. The shift elements E,F are combinable as a double shift element E/F in the engaging device S3.

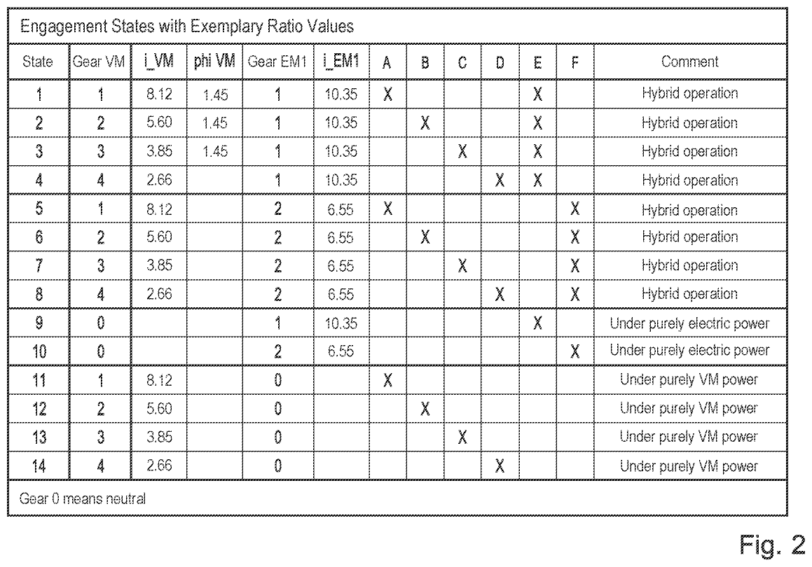

When both the shift elements E, F are disengaged, both the first electric machine EM1 and the planetary transmission PG are decoupled and cause no drag losses during the driving operation under purely internal combustion engine power (states 11-14 in FIG. 2). “Under purely internal combustion engine power” means that the large, first electric machine EM1 is decoupled. A smaller, second electric machine EM2 rotates, however, provided that it is present.

In the present invention, the planetary transmission PG is arranged coaxially to the first input shaft 7 and the spur gear stage ic with respect to the first countershaft 11 is connectable to the output of the planetary transmission (e.g., the carrier 23 or the ring gear 22). It is advantageous to utilize the first countershaft 11 and not the second countershaft 9, since a gear stage iab1 provides a higher ratio than a gear stage iab2. A high ratio for the first electric machine EM1 is advantageous as a higher rotational speed and less torque is possible.

The mode of operation is as follows:
a plurality of engagement states is possible including operation under purely electric power (states 9, 10 in FIG. 2), operation under purely internal combustion engine power (states 11-14 in FIG. 2), and hybrid operation (states 1-8 in FIG. 2).
the two electric gears E1 and E2 are not power shiftable with one another.
in the hybrid mode, powershifts are possible due to electrical tractive force support with the first electric machine EM1.

As a result:
the affected countershaft is axially shorter and, thus, takes up less installation space.
the planetary transmission PG is nested in the rotor of the first electric machine EM1 when the first electric machine EM1 is coaxial to the internal combustion engine VM.

The transmission 2 is utilized for a driving operation under purely electric power, a driving operation under purely internal combustion engine power, and a hybrid operation. The gear shift matrix from FIG. 2 summarizes, with the states 1-14, the particular possible driving operations, gears, and exemplary gear stages of the transmission in the particular gears. Shift elements that are engaged in the particular gear and/or state of the transmission 2 are marked with an X in the gear shift matrix from FIG. 2. The ratio values in the gear shift matrix from FIG. 2 are merely examples.

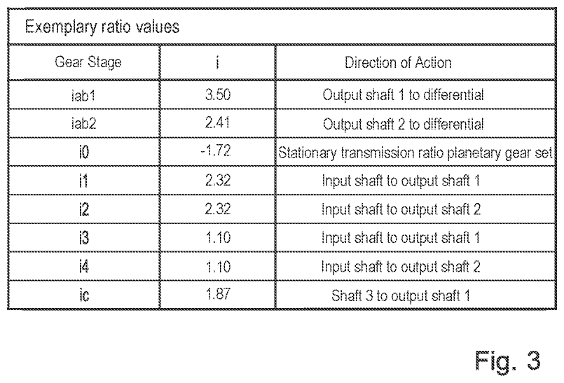

The ratio values in the gear stage matrix from FIG. 3 are merely examples showing the relative ratios of the gear stages.

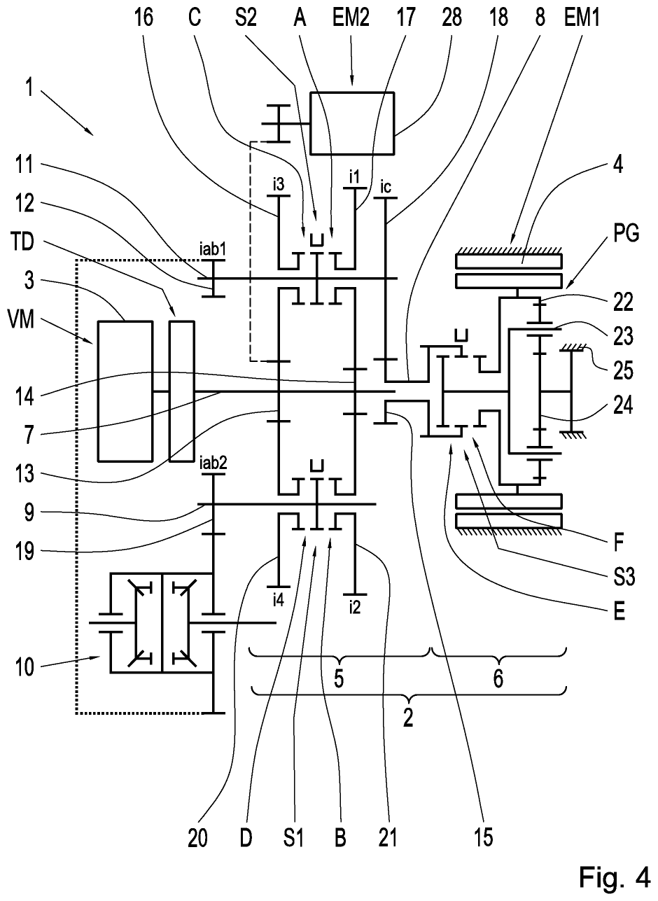

FIG. 4 shows a modification of the exemplary embodiment from FIG. 1, in which the input shaft 7 does not extend to the end of the transmission 2. The advantages and disadvantages are of a structural nature, for example, with respect to mounting.

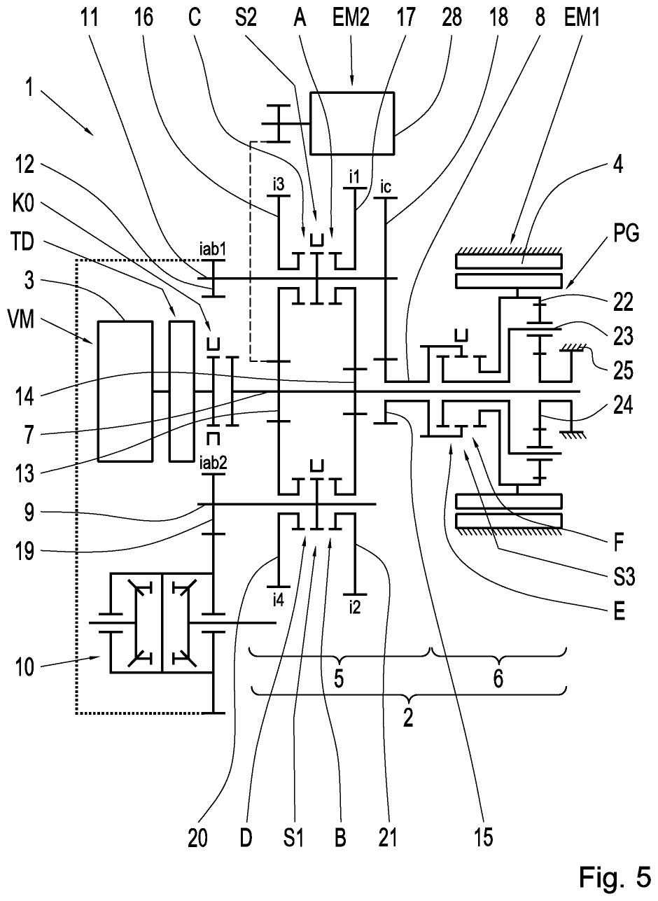

FIG. 5 shows one further modification of the exemplary embodiment from FIG. 1, in which a separating clutch KO for the internal combustion engine VM has been included. The separating clutch KO is a dog clutch or, alternatively, as a friction clutch. The provision of the separating clutch KO has the following advantages:
with the separating clutch KO disengaged, a purely electric driving operation with the second electric machine EM2 is possible (use of the gears V1, V2, V3, V4).
with the separating clutch KO disengaged, a driving operation under purely electric power with the first and second electric machines EM1, EM2 together is possible, wherein the particular gears are combined in any way.
in the driving operation under purely electric power (with the separating clutch KO disengaged), the second electric machine EM2 assists the tractive force while the first electric machine EM1 changes the gear.
in the driving operation under purely electric power (with the separating clutch KO disengaged), the first electric machine EM1 assists the tractive force while the second electric machine EM2 changes the gear.

If the separating clutch KO is a friction clutch, further advantages result:
the separating clutch KO also disengages under load, for example, during a full application of the brakes or a malfunction of the internal combustion engine VM.
the separating clutch KO also engages under differential speed, and so a so-called “flywheel start” of the internal combustion engine VM with the second electric machine EM2 is possible (utilization of the inertial mass of the second electric machine EM2 to start the internal combustion engine).

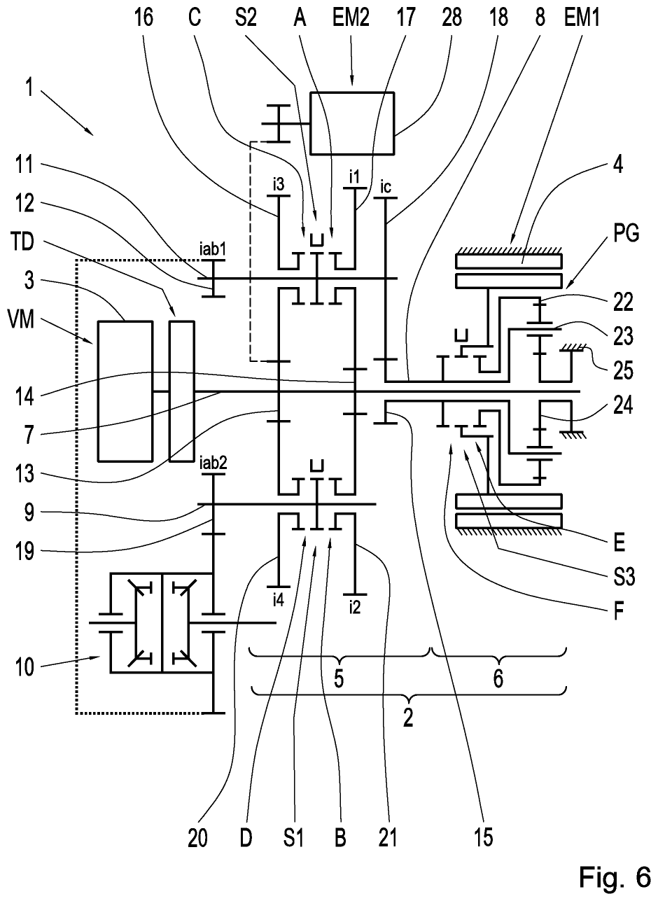

FIG. 6 shows one further modification of the exemplary embodiment from FIG. 1, in which the rotor of the first electric machine EM1 is not permanently connected to the ring gear, but rather is switched between being connected to the ring gear 22 or being connected to the carrier 23 via the engaging device S3 in the form of the double shift element E/F. The carrier 23 is permanently connected to the second input shaft 8.

As a result, the planetary transmission PG is not decouplable and also is not interlockable. At higher driving speeds, high rotational speeds arise at the ring gear 22 and at the planetary gears.

The gear shift matrix and functions are identical to the embodiment according to FIG. 1.

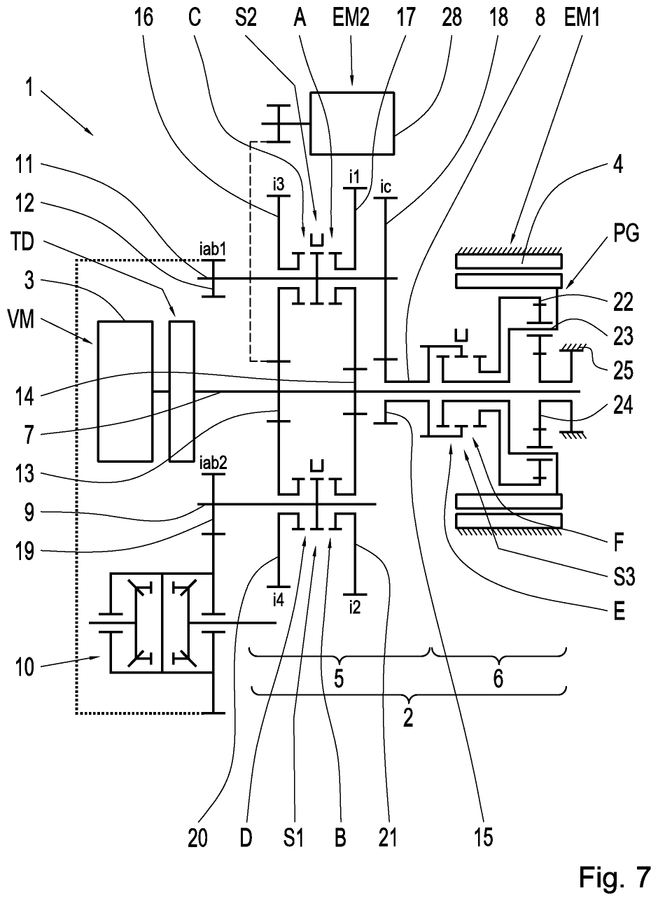

FIG. 7 shows one further modification of the exemplary embodiment from FIG. 1, in which:
the planetary transmission PG is interconnected differently, with the first electric machine EM1 being connected to the carrier 23.
in the engagement position F, the planetary transmission PG has a speed-increasing ratio.
the spur gear transmission ratio is is therefore adapted, where a higher ratio is selected than in the case of FIG. 1, and so appropriate ratios arise once again for the first electric machine EM1 and the electric gears E1 and E2.

This yields the following advantages:
in the main electric driving gear E1 (shift element E engaged), the efficiency is good (no power in the rolling planetary transmission).

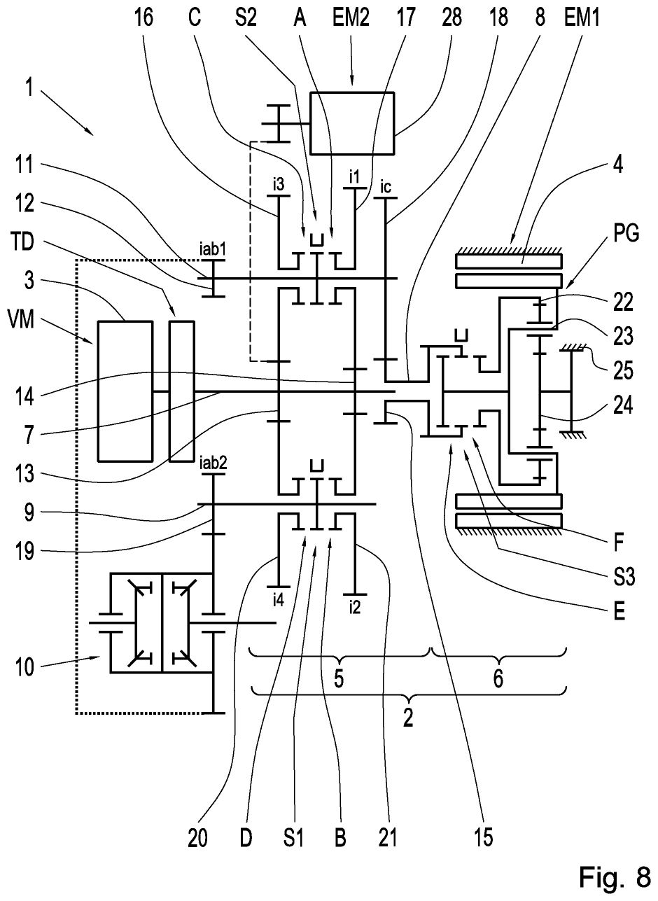

FIG. 8 shows a modification of the exemplary embodiment from FIG. 7, in which the input shaft 7 does not extend to the end of the transmission. The advantages and disadvantages are of a structural nature. This modification is implemented in all embodiments.

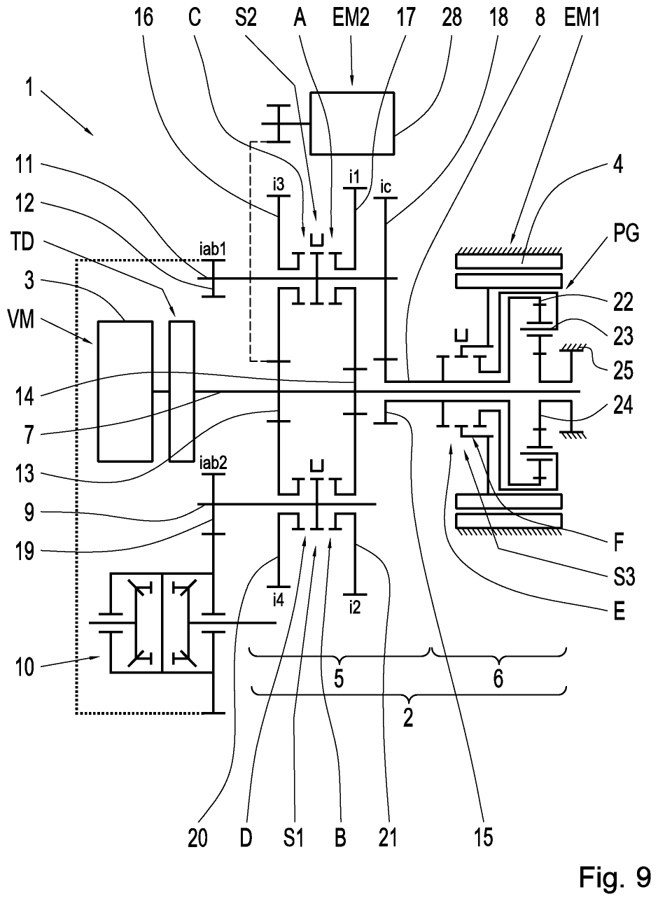

FIG. 9 shows a modification of the exemplary embodiment from FIG. 7, in which:
the rotor of the first electric machine EM1 is not permanently connected to the ring gear 22, but rather is switched between being connected to the ring gear 22 or being connected to the carrier 23 via the double shift element E/F. The ring gear 22 is permanently connected to the second input shaft 8.
in the engagement position F, the planetary transmission PG has a speed-increasing ratio.

As a result, the planetary transmission PG is not decouplable and also is not interlockable. At higher driving speeds, high rotational speeds arise at the ring gear 22 and at the planetary gears (due to the high ratio of the spur gear stage ic).

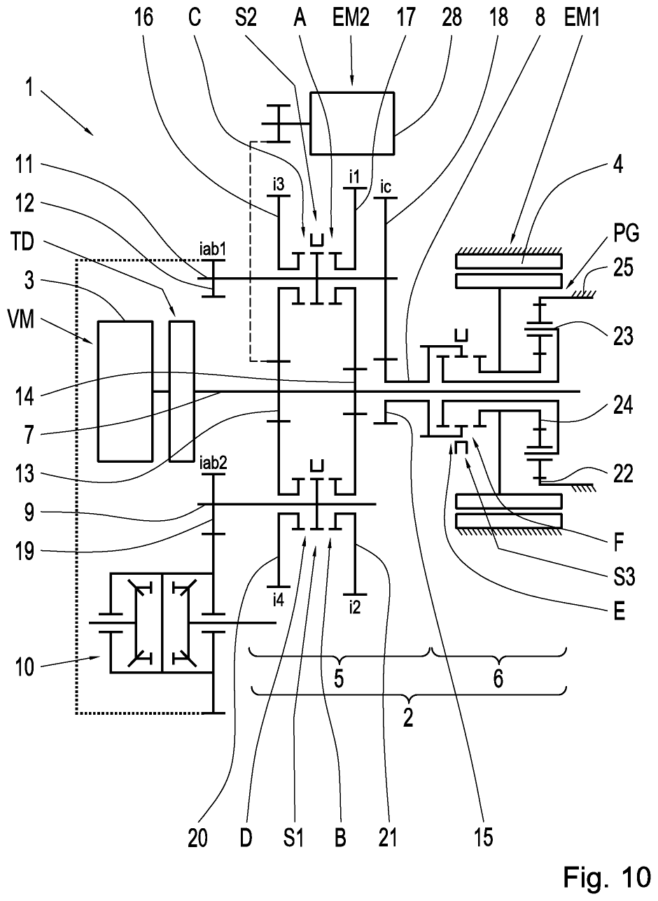

FIG. 10 shows one further modification of the exemplary embodiment from FIG. 1, in which the planetary transmission PG is connected differently, with the connection of the ring gear 22 and the sun gear 24 being interchanged. The ring gear 22 is permanently fixed to the housing. The sun gear 24 is connected to the rotor of the first electric machine EM1. This yields the following differences from the embodiment according to FIG. 1.
the electric machine EM1 has a considerably higher ratio in the gear E1 (for example, 17.82 in FIG. 10 and 10.35 in FIG. 1).
one advantage is that the first electric machine EM1 has a lower torque demand.
the gear E2 has the same ratio as in FIG. 1.
if such a high ratio is not needed in the gear E1, the ratio of the spur gear stage ic is reduced, for example.
the ratios for the internal combustion engine VM and, if necessary, the second electric machine EM2 are unaffected.

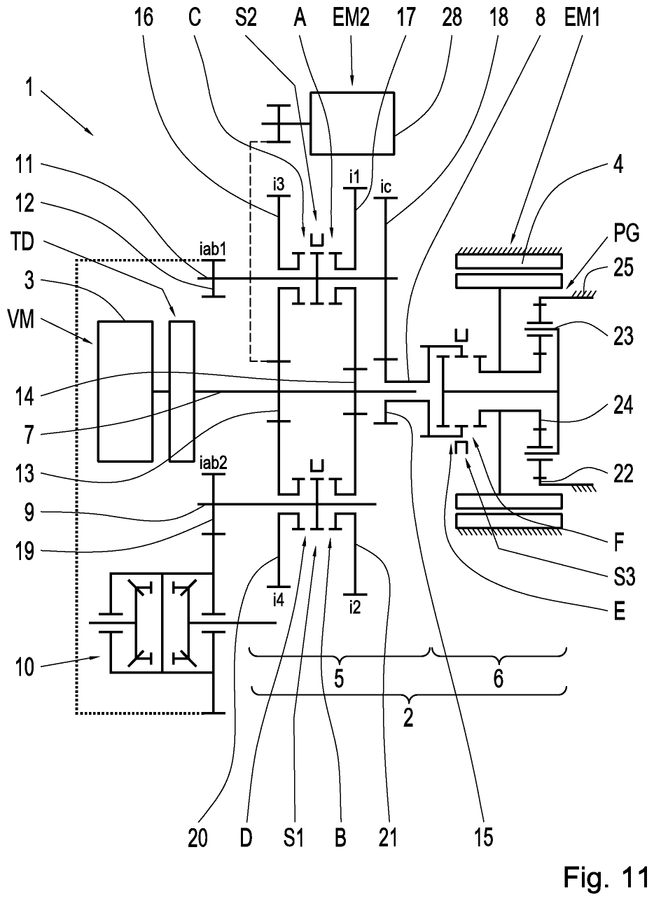

FIG. 11 shows a modification of the exemplary embodiment from FIG. 10, in which the input shaft 7 does not extend to the end of the transmission. The advantages and disadvantages are of a structural nature.

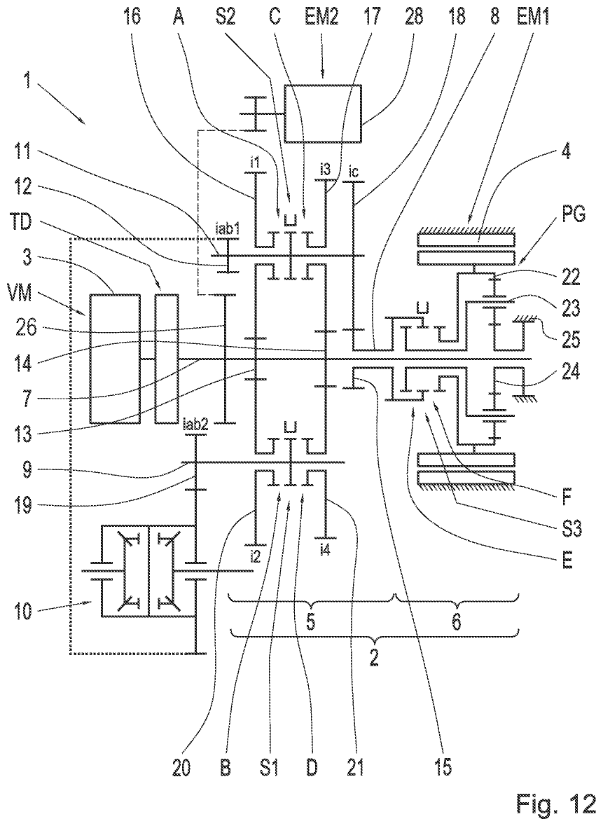

FIG. 12 shows one further modification of the exemplary embodiment from FIG. 1, in which the second electric machine EM2 is connected to the input shaft 7, namely via an intermediate gear 26. The modification is functionally equivalent to the embodiment according to FIG. 1, since the input shaft 7 is permanently operatively connected to the internal combustion engine VM.

This modification is implementable in all described embodiments.

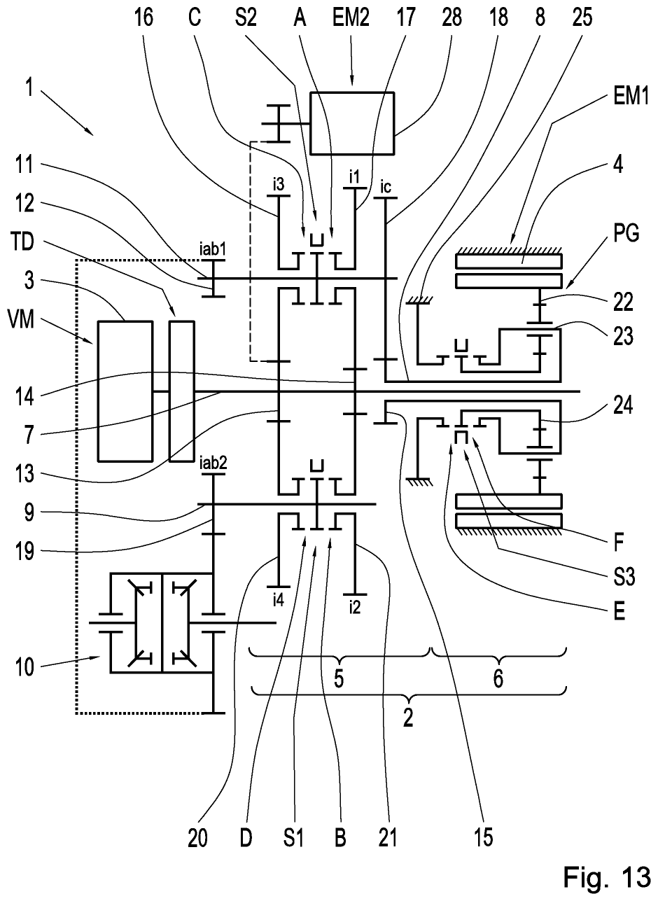

FIG. 13 shows one further modification of the exemplary embodiment from FIG. 1, in which:
the sun gear 24 for the gear E1 is fixable to the housing by engaging the shift element E.
for the second electric gear E2, the planetary transmission is interlockable, where two of the three elements are connectable to each other, by engaging the shift element F.
it is advantageous when shift element E and shift element F are part of a double shift element, for example, the engaging device S3.
since the sun gear 24 is engageable against the housing 25, two reasonable variants remain for interlock via the shift element F: the sun gear 24 with the ring gear 22 or the sun gear 24 with the carrier 23.
the connection of the ring gear 22 to the carrier 23 would also be possible, although the double shift element would not be possible.

In this embodiment, the planetary transmission is not decouplable, however.

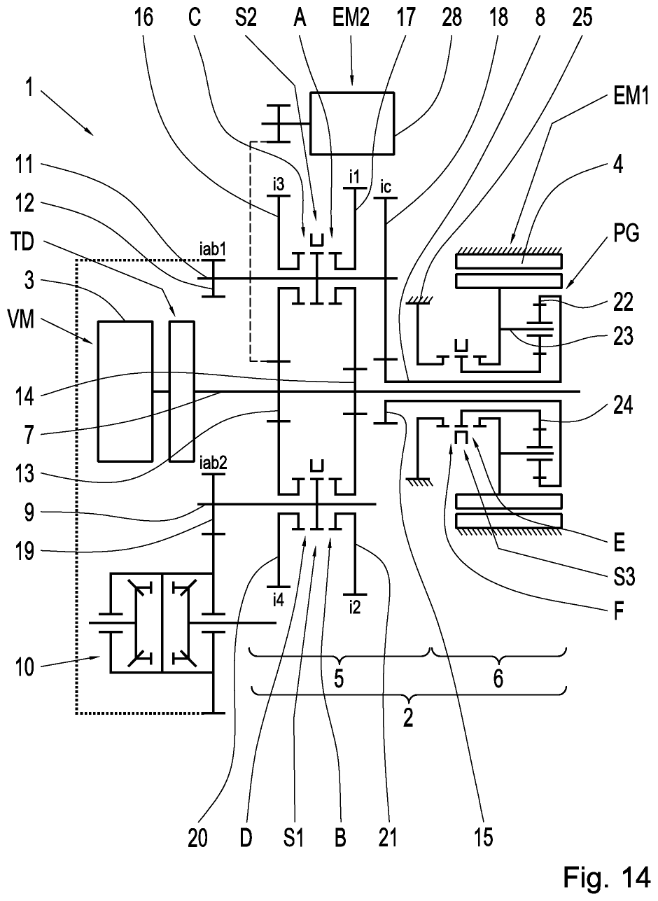

FIG. 14 shows a modification of the exemplary embodiment from FIG. 13, in which:
the planetary transmission PG is interconnected differently, with the first electric machine EM1 being connected to the carrier 23.
in the engagement position F, the planetary transmission PG has a speed-increasing ratio.
the spur gear ratio is is adapted (a higher ratio is selected than in FIG. 13), and so appropriate gear ratios arise once again for the first electric machine EM1.

This has the advantage that the efficiency for the first electric machine EM1 is good in the first electric gear E1 (shift element E engaged), since no power remains in the planetary transmission, since it is interlocked. However, the planetary transmission is not decouplable.

All embodiments have the following features or can have the following features:

The first electric machine EM1, which is arranged, in particular, coaxially to the input shafts, is fitted, in entirety, at the end of the transmission. An actuator for actuating the engaging device S3 having the shift elements E/F reaches the engaging device S3 from the outside on the transmission side. This is particularly useful in the case of a particularly large and powerful, first electric machine EM1 when the engaging device S3 having the shift elements E/F as well as the planetary transmission PG are at least partially radially nestable within the rotor of the first electric machine EM1. This has the advantage that axial installation space is saved.

The input shaft 7 does not need to extend to the end of the transmission 2. Alternatively, the input shaft 7 ends at the fixed gear of the spur gear stages i1/i2. It is structurally useful, however, for mounting-related reasons, to lengthen the input shaft 7 as indicated in the diagram.

It is advantageous to provide an additional starter generator (e.g., the second electric machine EM2) fixedly connected to the internal combustion engine VM, since charging at a standstill is not possible with the first electric machine EM1.

The second electric machine EM2 is preferably connected to an intermediate gear at the fixed gear of the spur gear stages i3/i4, which has a larger diameter than the fixed gear of the spur gear stages i1/i2.

Alternatively, the second electric machine EM2 is connected, as a coaxial electric machine, to the input shaft 7.

Alternatively, the second electric machine EM2 could be mounted at the belt drive of the internal combustion engine VM.

Alternatively, the second electric machine EM2 could be connected to an additional fixed gear on the first input shaft 7. As another alternative, the second electric machine EM2 could be connected to an idler gear of the countershafts 9 or 11, since a permanent operative connection to the first input shaft 7 arises in this way.

The following functions are covered with the second electric machine EM2, provided that the second electric machine EM2 is present:

internal combustion engine start during purely electric driving.
supply of the vehicle electrical system.
serial creeping and serial driving forward/backwards, where the second electric machine EM2 generates current for the first electric machine EM1 in the engagement states 9 and 10.
support of the closed-loop control of the rotational speed of the internal combustion engine during coupling and during gear shifts a synchronization of constant-mesh shift elements, for example, during gear shifts, is advantageously carried out by closed-loop control of the rotational speed at an electric machine.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 transmission system
2 transmission
3 first prime mover/internal combustion engine
4 second prime mover/electric machine
5 first sub-transmission
6 second sub-transmission
7 first input shaft
8 second input shaft
9 second countershaft/output shaft
10 drive output
11 first countershaft
12 fixed gear
13 idler gear
14 idler gear
15 idler gear
16 fixed gear
17 idler gear
18 idler gear
19 fixed gear
20 fixed gear
21 fixed gear
22 ring gear
23 carrier
24 sun gear
25 housing
26 intermediate gear
28 third prime mover/electric machine
A shift element
B shift element
C shift element
D shift element
E shift element
F shift element
KO separating clutch
EM1 first electric machine
EM2 second electric machine
VM internal combustion engine
i1-i4 gear stages
iab1 gear stage
iab2 gear stage
ic gear stage

1-9. (canceled)

10. A transmission (2) of a motor vehicle, comprising:
a first input shaft (7);
a second input shaft (8);
an output shaft (9);
a first sub-transmission (5) including the first input shaft (7);
a second sub-transmission (6) including the second input shaft (8), the second sub-transmission (6) being a planetary transmission having components including a sun gear (24), a ring gear (22), and a carrier (23); and
an engaging device (S3) associated with the planetary transmission (PG),
wherein, in a first engagement position (E) of the engaging device (S3), a first component (23) of the components of the planetary transmission (PG) is connected to the second input shaft (8), and
wherein, in a second engagement position (F) of the engaging device (S3), a second component (22) of the components of the planetary transmission (PG) is connected to the second input shaft (8).

11. The transmission of claim 10, further comprising:
a countershaft (11); and
a gearwheel (15) coaxial to the first input shaft (7),
wherein the second output shaft (8) is permanently coupled to the countershaft (11) via the gearwheel (15).

12. The transmission of claim 11, further comprising a gearwheel (18) on the countershaft (11), the gearwheel (18) being coupled to the second input shaft (8), the gearwheel (18) being a fixed gear.

13. The transmission of claim 10, further comprising two fixed gears (13, 14) on the first input shaft (7).

14. The transmission of claim 10, wherein the ring gear (22) of the planetary transmission is connected to a second prime mover (4).

15. The transmission of claim 10, wherein the first input shaft (7) is operatively connected to an electric machine (28).

16. The transmission of claim 10, wherein a fixed gear (13) on the first input shaft (7) or a fixed gear (16) on a countershaft (11) is coupled to a third prime mover (28).

17. The transmission of claim 10, further comprising a separating clutch (KO) associated with the first input shaft (7) for selective decoupling a first prime mover (3) from the first input shaft (7).

18. A transmission system of a motor vehicle, comprising:
the transmission (2) of claim 10;
a first prime mover (3) coupled or coupleable to the first input shaft (7);
a second prime mover (4) coupled or coupleable to the second input shaft (8); and
a drive output (10) coupled to the output shaft (9).
